(19) United States
(12) Patent Application Publication
(10) Pub. No.: US 2013/0169207 A1
(43) Pub. Date: Jul. 4, 2013

(54) METHOD AND DEVICE FOR PROTECTING AN INVERTER POWER SWITCHING SEMICONDUCTOR DEVICE FROM THERMAL CYCLING

(71) Applicants: Mark Oliver Todd, Louisville, KY (US); Shyam Sunder Ramamurthy, Louisville, KY (US)

(72) Inventors: Mark Oliver Todd, Louisville, KY (US); Shyam Sunder Ramamurthy, Louisville, KY (US)

(73) Assignee: General Electric Company, Schenectady, NY (US)

(21) Appl. No.: 13/342,622

(22) Filed: Jan. 3, 2012

(51) Int. Cl. H02H 7/085

(52) U.S. Cl. 318/472

(57) ABSTRACT

A method and device for protecting a power switching semiconductor inverter from thermal cycling is disclosed. The method compares the actual frequency of the inverter to a low fundamental frequency of the inverter and compares the actual current of the inverter to a continuous current rating of the inverter. A thermal cycling condition is detected if both (a) the actual frequency is lower than the low fundamental frequency and (b) the actual current is higher than the continuous current rating. A thermal cycling fault condition is detected when the inverter has been in the thermal cycling operating condition for a sufficient period of time to cause its present stress factor to exceed a predetermined rated stress factor.

### BACKGROUND OF THE INVENTION

The subject matter disclosed herein relates to the protection of inverter power switching semiconductor devices from thermal cycling.

Inverter power switching semiconductor devices convert direct current to alternating current and do so in a fashion that controls the properties of the resulting waveform. Certain operating parameters (speed, torque, etc.) of a device are controlled by this waveform. As the inverter power switching semiconductor device is used, excessive thermal cycling can occur as the inverter repeatedly heats up and then cools down. The life expectancy of inverter power switching semiconductor devices can be negatively impacted by a number of variables, including the degree of thermal cycling.

Prior methods of addressing thermal cycling problems use voltage, current, temperature or physical apparatuses to decrease thermal cycling. Many of these protection mechanisms only monitor temperature faulting and not the actual thermal cycling of the device. Some prior art devices use an oversized semiconductor so that extreme thermal cycling is not a problem. Other systems predict when a system is near the end of its useful lifetime and then limit the frequency and current that is supplied. Still other techniques modify the pulse width modulation (PWM) signal based on vector control algorithms, but such approaches are impractical for high power systems. While each of these approaches has been implemented, none has proven entirely satisfactory.

It is therefore desirable to provide an alternative method and device for protecting an inverter power switching semiconductor device from thermal cycling. This addresses the problem of decreased longevity of inverter power switching semiconductor devices as a result of thermal cycling.

The discussion above is merely provided for general background information and is not intended to be used as an aid in determining the scope of the claimed subject matter.

### BRIEF DESCRIPTION OF THE INVENTION

A method and device for protecting a power switching semiconductor inverter from thermal cycling is disclosed. The method compares the actual frequency of the inverter to a low fundamental frequency of the inverter and compares the actual current of the inverter to a continuous current rating of the inverter. A thermal cycling condition is detected if both (a) the actual frequency is lower than the low fundamental frequency and (b) the actual current is higher than the continuous current rating. A thermal cycling fault condition is detected when the inverter has been in the thermal cycling operating condition for a sufficient period of time to cause its present stress factor to exceed a predetermined rated stress factor.

One problem of inverter power switching semiconductor devices is their decreased longevity as a result of damage caused by thermal cycling. The present method and device monitors certain parameters of the inverter and takes a specified action when particular high-stress events occur. The technical effect is the reduction of damage caused by thermal cycling and an increase in the longevity of the inverter. An advantage that may be realized in the practice of some disclosed embodiments of the method and device is the increase in inverter longevity due to the reduction in thermal cycling.

In one exemplary embodiment, a method for protecting a power switching semiconductor inverter from thermal cycling and a program storage device for performing the method is disclosed. The method comprises the steps of monitoring an actual current and an actual frequency of an inverter, comparing the actual frequency of the inverter to a low fundamental frequency of the inverter, comparing the actual current of the inverter to a continuous current rating of the inverter, detecting a thermal cycling operating condition if both (a) the actual frequency is lower than the low fundamental frequency and (b) the actual current is higher than the continuous current rating, and detecting a thermal cycling fault condition when the inverter has been in the thermal cycling operating condition for a sufficient period of time to cause its present stress factor to exceed a predetermined rated stress factor, the present stress factor being determined by monitoring both the actual current and the actual frequency as a function of time while the inverter is in the thermal cycling operating condition.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a schematic depiction of an exemplary system for protecting an inverter from thermal cycling;

FIG. 2 is graph illustrating an exemplary thermal cycling of an inverter operating at two different frequencies;

FIG. 3 is a graph illustrating the time until a thermal cycling fault condition versus frequency of an exemplary inverter operating at three different current levels;

FIG. 4 is a schematic depiction of the exemplary inputs and outputs of the programmable logic controller; and

FIG. 5 is an exemplary flow diagram of a method for determining a thermal cycling operating condition that can cause damaging thermal cycling to the inverter.

### DETAILED DESCRIPTION OF THE INVENTION

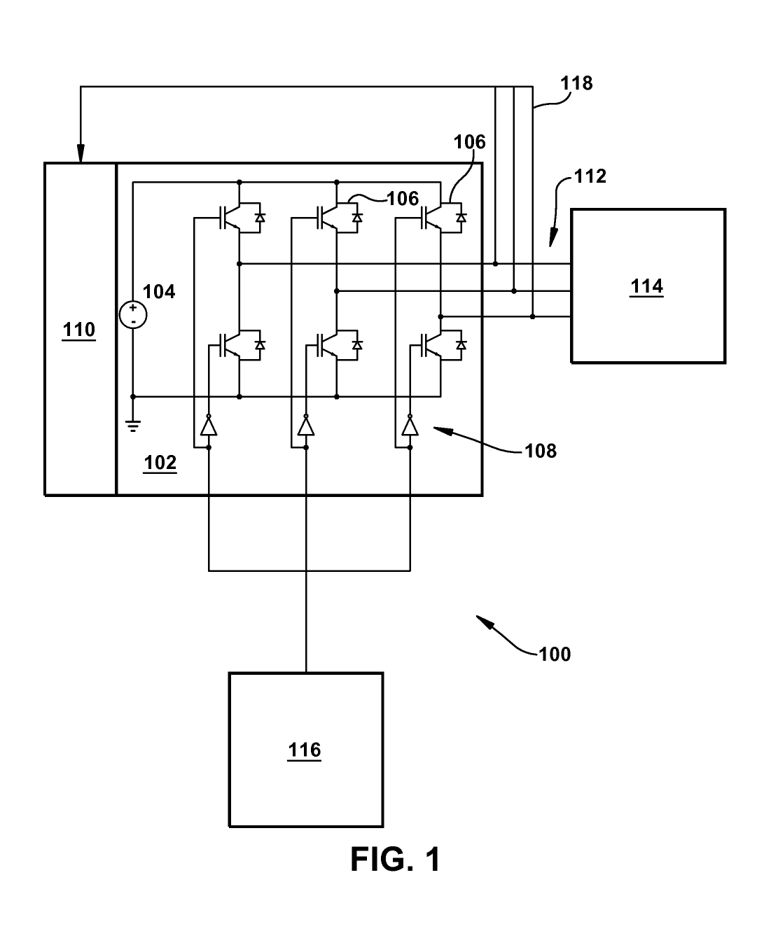

FIG. 1 is a schematic depiction of an exemplary system 100 for protecting an inverter power switching semiconductor device (an “inverter”) 102 from thermal cycling. System 100 comprises an inverter 102 for controlling a device 114. Exemplary embodiments of device 114 include construction equipment (e.g. an excavator, mining equipment, turbines, mill equipment, etc.) and other electronically controlled motors driven at variable frequency.

In one embodiment, inverter 102 comprises a power supply 104 and a plurality of insulated-gate bipolar transistors (IGBTs) 106. In the embodiment depicted in FIG. 1, there are three pairs of IGBTs 106, each pair being connected to a corresponding input 108 and output 112 of the inverter 102. Electrical signals are individually supplied to the three inputs 108 to control the resulting waveform that is transmitted through output 112 to the device 114. In the embodiment depicted, there are three outputs 112 for controlling a three phase device 114. Each of the three outputs 112 corresponds to one of the three inputs 108. By controlling the firing frequency of IGBTs 106, the frequency of the waveform is controlled. This waveform, in turn, controls the operating parameters of device 114 (e.g. speed, torque, etc.).

An operator 116 typically controls the signals that are sent to the input 108 of the inverter 102 with a driving circuit. In many prior art systems the user may abuse the inverter 102 and the device 114 by operating in a fashion that causes the inverter 102 to wear rapidly, decreasing the longevity of the inverter 102. One significant source of damage to the inverter 102 is thermal cycling caused by operating the inverter 102 at low frequencies.

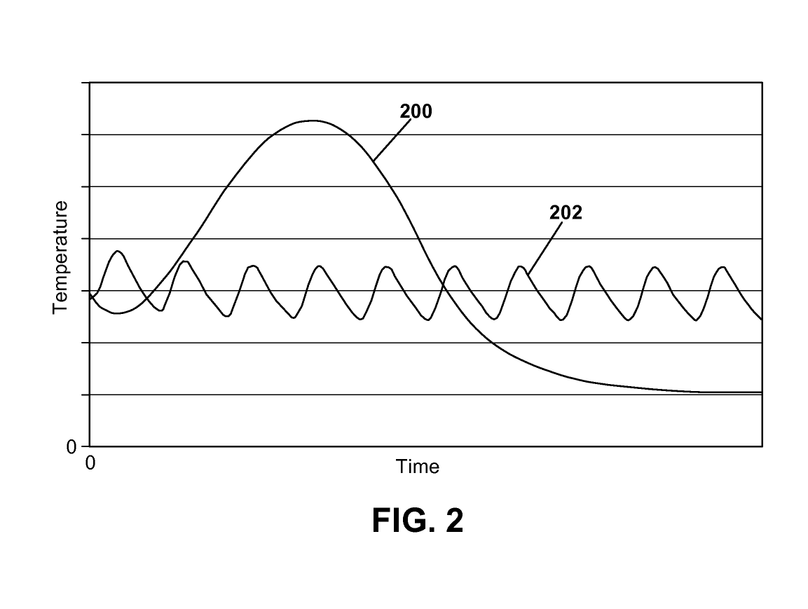

FIG. 2 is a graph illustrating an exemplary thermal cycling of an inverter 102 operating at two different frequencies 200, 202. As shown in FIG. 2, when operating the inverter 102 at a lower frequency 200 (e.g. 0.5 Hz), the inverter 102 more slowly cycles from its on or closed state (rising in temperature) to its off or open state (falling in temperature). This pattern results in the inverter 102 experiencing more extreme temperatures (higher and lower) and longer periods of time when the inverter 102 is experiencing those extreme temperatures, increasing the thermal cycling to which the inverter 102 is exposed. On the other hand, when operating at a higher frequency 202 (e.g, 5.0 Hz), the inverter 102 more quickly cycles from its on or closed state to its off or open state, avoiding operating at extreme temperatures and shortening the time at which the inverter experiences continuous heating or cooling and reducing thermal cycling. In order to address this thermal cycling concern, inverters 102 can be provided with a rating for a low fundamental frequency (e.g., 0.5 Hz) at or above which the inverter 102 (including its IGBTs 106) can operate continuously without significant damage from thermal cycling.

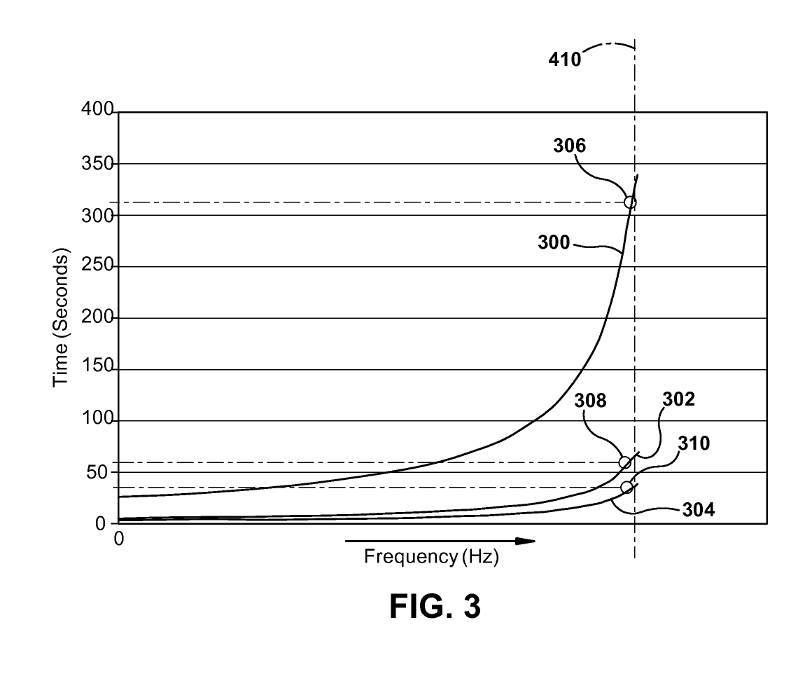

Thermal cycling is not only a function of the frequency at which the inverter 102 is operating, it is also a function of the current at which the inverter 102 is operating. FIG. 3 is a graph illustrating the time until a thermal cycling fault condition versus frequency of an exemplary inverter 102 operating at three different current levels 300, 302, 304 with reference to the rated low fundamental frequency (f_{Stall, 30}) 410 of the inverter 102. When the inverter 102 operates at a frequency above the low fundamental frequency (f_{Stall, 30}) 410, the prior art “I squared T” technique can be used to protect the inverter 102 from overcurrent conditions. The present system 100 for protecting an inverter 102 from thermal cycling is useful when the inverter 102 is operating at frequencies below low fundamental frequency (f_{stall, 30}) 410 and at current levels above the continuous current rating of the inverter 102, conditions that can cause damaging thermal cycling.

The graph of FIG. 3 shows three different current levels 300, 302, 304 at which the inverter 102 is operating at three different per unit (pu) currents as multiples of the continuous current rating of the inverter 102. The graph shows that, when the inverter 102 is operating below the low fundamental frequency (f_{Stall, 30}) 410 at lower current levels, there is a longer time until a thermal cycling fault condition is reached as compared to when operating at higher current levels. For example, when operating the inverter 102 at slightly below the low fundamental frequency (f_{Stall, 30}) 410 at current level 300 (1.1 times the continuous current rating, see point 306), there are over three hundred seconds before a thermal cycling fault condition is reached. When operating the inverter 102 at slightly below the low fundamental frequency (f_{Stall, 30}) 410 at current level 302 (1.5 times the continuous current rating, see point 308), there are approximately sixty seconds before a thermal cycling fault condition is reached. Finally, when operating the inverter 102 at slightly below the low fundamental frequency (f_{Stall, 30}) 410 at current level 304 (1.9 times the continuous current rating, see point 310), there are approximately thirty seconds before a thermal cycling fault condition is reached.

To determine when a thermal cycling fault condition will occur, system 100 of FIG. 1 includes a microcontroller, e.g., a programmable logic controller (PLC) 110. In some embodiments, the PLC 110 may be an integral part of the inverter 102, while in other embodiments, the PLC 110 may be separate from the inverter 102. In operation, the PLC 110 can be programmed with rating and performance information concerning the inverter 102 and the device 114 and also be provided with feedback information on the operation of the device 114 to determine when a thermal cycling fault condition may occur.

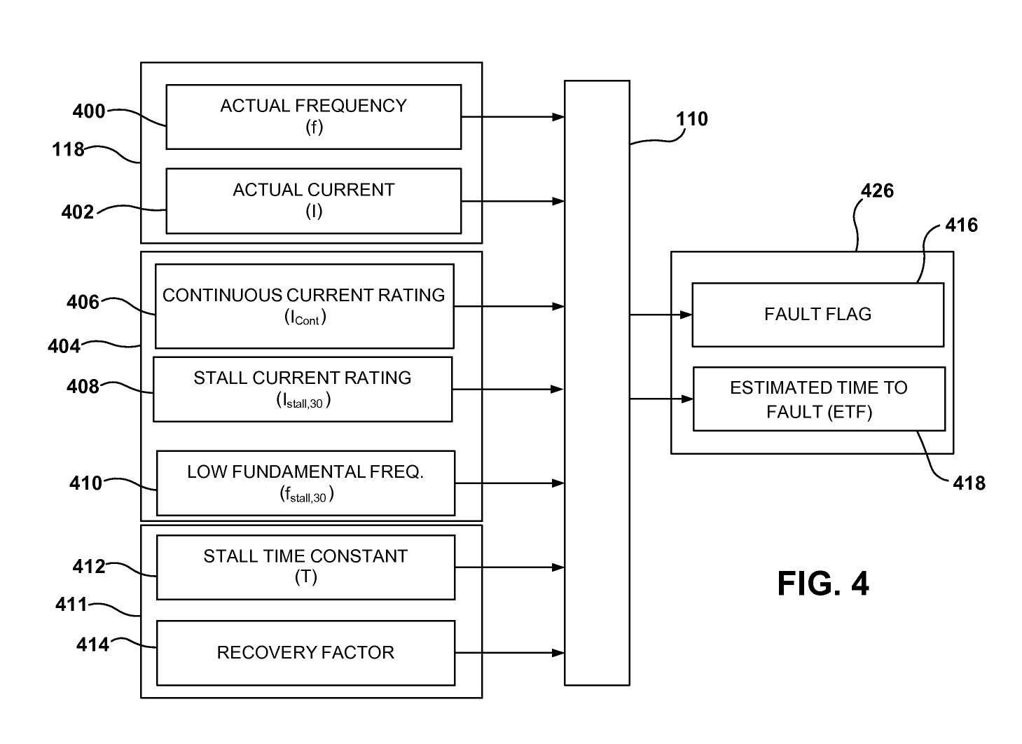

FIG. 4 is a schematic depiction of the exemplary inputs and outputs of the PLC 110. As shown in the logical schematic of FIG. 4, the feedback 118 from the output of the inverter 102 can comprise dynamic parameters such as the actual frequency (f) 400 and the actual root mean square (RMS) current (I) 402. Feedback 118 can be provided at the output 112 of the inverter 102 driving the device 114. The PLC 110 receives these dynamic parameters as inputs and can also be programmed with certain static parameters including those associated with the particular inverter 102 and the particular device 114 used. Inverter 102 has a number of such static parameters 404 including its continuous current rating (I_{Cont}) 406 (how much current the inverter 102 is rated to handle for a prolonged period of time, e.g. 600 amps) the stall current rating (I_{Stall, 30}) 408 (how much current the inverter 102 is rated to handle for a specified, short period of time, e.g. 1000 amps for 30 seconds), and the low fundamental frequency (f_{Stall, 30}) 410 (the lowest frequency at which the device is rated to operate at the continuous current rating (I_{Cont}) 406 for a short period of time, e.g. 0.5 Hz hertz for 30 seconds). The PLC 110 can also be provided with static parameters 411 that are based on the device 114 or particular application in which the inverter 102 is used, including the stall time constant (T) 412 (amount of time spent in a undesirable stress state before a thermal cycling fault condition is indicated, e.g., two seconds) and a recovery factor 414 (a scaling constant to control how quickly a thermal cycling fault condition is deemed clear after the imposed stress has been relieved, e.g. a number between 1-10 or a number between 1-100, etc.). In one embodiment, stall time constant (T) 412 is the time until failure when operating at zero frequency at the stall current rating (I_{Stall, 30}) 408.

PLC 110 uses one or more of the above parameters 118, 404, 411 to calculate certain values (e.g., dynamic stress margin (Dₘ), rated stress factor (Sᵣ), and present stress factor (Sₚ)) that are then used to determine whether a thermal cycling fault condition has been reached or to estimate the time until a thermal cycling fault condition will be reached. PLC 110 can then display output 426 to the operator 116 to indicate that a thermal cycling fault condition has or will soon be reached. Examples of displayed output 426 include a fault flag 416 which is a perceptible indicator that notifies the operator 116 that a thermal cycling fault condition has been reached. In one embodiment, output 426 includes an estimated time to fault (ETF) 418, providing the operator 116 with a warning of the amount of time remaining before a thermal cycling fault condition is reached.

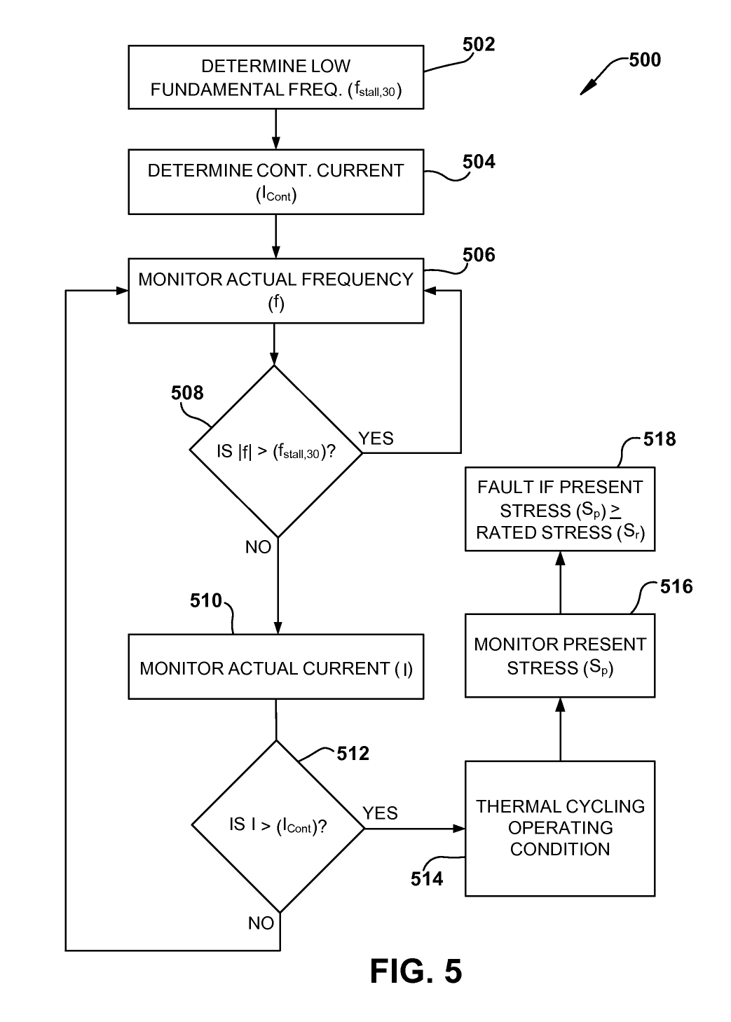

FIG. 5 is an exemplary flow diagram of a method for determining a thermal cycling operating condition that can cause damaging thermal cycling to the inverter 102. As shown in the graph of FIG. 3, the present system 100 for protecting an inverter 102 from thermal cycling is useful when the inverter 102 is operating at frequencies below low fundamental frequency (f_{Stall, 30}) 410, and at actual current levels (I) above the continuous current rating (I_{Cont}) 406 of the inverter 102, conditions that can produce damaging thermal cycling. If either of those conditions are not met, then the prior art “I squared T” technique can be used to protect the inverter 102 from overcurrent conditions.

Referring to FIG. 5, method 500 is depicted which begins with steps 502 and 504 wherein the low fundamental frequency (f_{Stall, 30}) 410 and the continuous current rating (I_{Cont}) 406 of inverter 102 are determined. Each parameter may be determined by loading the parameter into the memory of PLC 110 from a data storage device which holds the static parameters of inverter 102. In step 506, the actual frequency (f) 400 is monitored by monitoring feedback 118 (see FIG. 1). In one embodiment, the actual frequency (f) 400 is continually monitored in real time. In another embodiment, the actual frequency (f) 400 is monitored at a predetermined interval (e.g. every 0.5 seconds, every one second, every two seconds, etc.). In step 508, the absolute value of the actual frequency (f) 400 is compared to the low fundamental frequency (f_{Stall, 30}) 410 of inverter 102. In one embodiment, comparison step 508 occurs continually in real time. In another embodiment, comparison step 508 occurs at a predetermined interval. If the absolute value of the actual frequency (f) 400 is greater than (or, in certain embodiments, equal to) the low fundamental frequency (f_{Stall, 30}) 410, then the method 500 returns to step 506. In certain embodiments, if the absolute value of the actual frequency (I) 400 is greater than (or, in certain embodiments, equal to) the low fundamental frequency (f_{Stall, 30}) 410, the stress on the inverter 102 can then be monitored according to the “I squared T” technique between steps 508 and 506. If the actual frequency (f) 400 is less than the low fundamental frequency (f_{Stall, 30}) 410 (or, in certain embodiments, equal to the low fundamental frequency (f_{Stall, 30}) 410) then step 510 is executed.

In step 510 the actual current (I) 402 is monitored by monitoring feedback 118. In one embodiment, actual current (I) 402 is continually monitored in real time. In another embodiment, actual current (I) 402 is monitored at a predetermined interval. The actual current (I) 402 is compared to the continuous current rating (I_{Cont}) 406 in step 512. In one embodiment, comparison step 512 occurs continually in real time. In another embodiment, comparison step 512 occurs at a predetermined interval. If the actual current (I) 402 is less than (or, in certain embodiments, equal to) the continuous current rating (I_{Cont}) 406, then the method 500 returns to step 506. If the actual current (I) 402 is greater than the continuous current rating (I_{Cont}) 406 (or, in certain embodiments, equal to the continuous current rating (I_{Cont}) 406) then a thermal cycling operating condition is determined at step 514 that requires further analysis to determine if a thermal cycling fault condition is or will be reached. Table 1 summarizes the conditions when an thermal cycling operating condition may be determined.

TABLE 1

| | | Thermal Cycling Operating |
|---|---|---|
| Actual Current (I) | Actual Frequency (f) | Condition? |
| Low | Low | No |
| Low | High | No |
| High | Low | Yes |
| High | High | No |

Once a thermal cycling operating condition is detected in step 514, the present stress factor (Sₚ) experienced by inverter 102 is monitored in step 516. This present stress factor (Sₚ) is compared to a rated stress factor (Sᵣ) in step 518 to determine if a thermal cycling fault condition is present. If the present stress factor (Sₚ) is equal to or exceeds the rated stress factor (Sᵣ), then a thermal cycling fault condition is detected. If the thermal cycling operating condition terminates before a fault condition is detected, the method 500 clears the present stress factor (Sₚ) measurement and returns to step 506 to continue to monitor the actual frequency and current.

An advantage that may be realized in the practice of some embodiments of the described method and device is the detection of those events (high current paired with low frequency) which produce thermal cycling operating conditions that are particularly damaging to the inverter 102. Detection of such a condition can be used to increase the longevity of the inverter 102. Once the thermal cycling operating condition is determined, the PLC 100 determines if a thermal cycling fault condition is or will be reached. In one embodiment, the thermal cycling fault condition is detected by integrating the current and frequency as a function of time. This embodiment is described in detail below.

In one embodiment, the rated stress factor (Sᵣ) is calculated according to equation 1 based on the stall current rating (I_{Stall, 30}) 408, the continuous current rating (I_{Cont}) 406 of the inverter, and the stall time constant (T) 412 of the device 114 or particular application. The rated stress factor (Sᵣ) provides a metric that reflects the maximum thermal cycling stress inverter 102 is rated to tolerate.

$${S}_{r} = \frac{{I}_{Stall , 30} - {I}_{Cont}}{{I}_{Cont}} \times T \qquad ( 1 )$$

The present stress factor (Sₚ) is calculated according to equation 2 based on the actual current (I) 402, actual frequency (f) 400, continuous current rating (I_{Cont}) 406, and the low fundamental frequency (f_{Stall, 30}) 410 of the inverter 102. Sₚ provides a metric that reflects the actual thermal cycling stress currently experienced by inverter 102.

$${S}_{p} = Min [ Max [ \int \frac{I - {I}_{Cont}}{{I}_{Cont}} X \vert \frac{( \vert f \vert - {f}_{Stall , 30}}{{f}_{Stall , 30}} \vert d t , 0 ] , {S}_{r} ] \qquad ( 2 )$$

When the actual current (I) 402 is less than the continuous current rating (I^{Cont}) 406,

$$\frac{I - {I}_{Cont}}{{I}_{Cont}}$$

will be set to a negative value, resulting in the present stress factor (Sₚ) being set to zero (step 512 is performed) to indicate a thermal cycling operating condition is not present. Present stress factor (Sₚ) is set equal to the value of the integral if the integral is positive but is less than the rated stress factor (Sᵣ). Such a value indicates a thermal cycling operating condition is present and there is the potential for a thermal cycling fault condition. Present stress factor (Sₚ) is set equal to the rated stress factor (Sᵣ) in the event the integral is positive and exceeds the rated stress factor (Sᵣ). Since the integral is the area under the curve of the current and frequency functions shown in equation 2, the present stress factor (Sₚ) reflects the cumulative stress experienced by the inverter 102 while it is in a thermal cycling operating condition and takes into account both stress caused by the actual current (I) 402 and the actual frequency (f) 410.

In one embodiment, the dynamic stress margin (Dₘ) is calculated according to equation 3.

Dₘ=Sᵣ−Sₚ (3)

When the present stress factor (Sₚ) is zero (e.g. the actual current (I) is less than the continuous current rating (I_{Cont}) 406) Dₘ equals Sᵣ. When Sₚ is a positive value that is less than Sᵣ then Dₘ is a positive number that provides a metric indicative of the remaining stress margin before a fault condition occurs. When the present stress factor (Sₚ) is equal to the rated stress factor (Sᵣ) then Dₘ has a value of zero and a thermal cycling fault condition is detected.

When the thermal cycling fault condition is detected, a fault flag 416 (see FIG. 4) is displayed to the operator 116. The fault flag may comprise lights (strobe lights or various colors to denote status), text messages on a screen and/or audible sounds. In one embodiment, the fault flag 416 can also override the ability of operator 116 to send signals to the input 108 of inverter 102, thereby providing inverter 102 with an opportunity to recover. Once a thermal cycling fault condition is reached, the inverter 102 remains in a thermal cycling fault condition for so long as the dynamic stress margin (Dₘ) is equal to zero. When the dynamic stress margin (Dₘ) is no longer equal to zero, the system 100 may, in certain embodiments, remain in a faulted condition for an additional period of time. This period of time is determined, at least in part, by recovery factor 414. Recovery factor 414 is a scaling constant (e.g. 1-10) which is used by PLC 110 to determine how rapidly the thermal cycling fault condition will be deemed clear once a thermal cycling fault condition is no longer present. A recovery factor 414 of “10” may, for example, indicate a rapid recovery while a recovery factor 414 of “1” may indicate a prolonged recovery time to provide additional time for the inverter 102 to cool. The inclusion of a recovery factor 414 as a predetermined variable permits the thermal cycling protection to be adapted to a variety of different devices 114, each of which will have its particular timing requirements.

If the dynamic stress margin (Dₘ) is greater than zero, then a thermal cycling fault condition is not detected as the present stress factor (Sₚ) is less than the rated stress factor (Sᵣ). In equation 4, an estimated time to fault (ETF) 418 is calculated based on the dynamic stress margin (Dₘ).

$$E T F = \frac{{D}_{m}}{{S}_{p}} d t \qquad ( 4 )$$

In equation 5, dt is a pre-determined time interval at which integration takes place. Therefore, based on the dynamic stress margin (Dₘ), ETF 418 may be found.

In one embodiment, the method is executed as a computer program. The computer program is stored on a program storage device readable by machine. Examples of program storage devices include optical discs such as compact discs, magnetic media such as hard drives, flash memory drives, and the like. The computer program may reside on a computer that is part of system 100. In another embodiment, the computer program is initially obtained on another program storage device and is thereafter installed on a computer that is part of system 100.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for protecting a power switching semiconductor inverter from thermal cycling comprising the steps of:
monitoring an actual current and an actual frequency of an inverter;
comparing the actual frequency of the inverter to a low fundamental frequency of the inverter;
comparing the actual current of the inverter to a continuous current rating of the inverter;
detecting a thermal cycling operating condition if both (a) the actual frequency is lower than the low fundamental frequency and (b) the actual current is higher than the continuous current rating; and
detecting a thermal cycling fault condition when the inverter has been in the thermal cycling operating condition for a sufficient period of time to cause its present stress factor to exceed a predetermined rated stress factor, the present stress factor being determined by monitoring both the actual current and the actual frequency as a function of time while the inverter is in the thermal cycling operating condition.

2. The method as recited in claim 1, wherein the actual frequency and the actual current are sensed in real time.

3. The method as recited in claim 1, wherein the actual frequency and the actual current are sensed at a predetermined interval.

4. The method as recited in claim 1, wherein the step of comparing the actual frequency to the low fundamental frequency and the step of comparing the actual current to the continuous current rating are performed in real time.

5. The method as recited in claim 1, wherein the step of comparing the actual frequency to the low fundamental frequency and the step of comparing the actual current to the continuous current rating are performed at a predetermined interval.

6. The method as recited in claim 1, further comprising the step of operating a motor, wherein the motor is controlled by the power switching semiconductor inverter.

7. The method as recited in claim 1 wherein, in the event a thermal cycling fault condition is detected, the method further including the step of overriding an operator that is causing the thermal cycling fault condition, thereby protecting the inverter from thermal cycling.

8. The method as recited in claim 7 wherein, in the event a thermal cycling fault condition is detected, further comprising the step of waiting for the thermal cycling fault condition to clear before returning control of the inverter to the operator.

9. The method as recited in claim 8, wherein the step of waiting for the thermal cycling fault condition to clear includes waiting for a predetermined period of time that is modified by a recovery factor.

10. The method as recited in claim 1, further comprising the step of displaying a fault flag in the event a thermal cycling fault condition is detected

11. The method as recited in claim 1, wherein the inverter comprises a plurality of pairs of insulated-gate bipolar transistors (IGBTs).

12. The method as recited in claim 11, wherein the plurality of pairs of IGBTs consists of three pairs of IGBTs, each pair operatively connected to a corresponding input and a corresponding output.

13. A program storage device readable by machine, tangibly embodying a program of instructions executable by machine to perform the method steps for protecting a power switching semiconductor inverter from thermal cycling comprising the steps of:
monitoring the actual current and the actual frequency of an inverter;
comparing the actual frequency of the inverter to a low fundamental frequency of the inverter;
comparing the actual current of the inverter to a continuous current rating of the inverter;
detecting a thermal cycling operating condition if both (a) the actual frequency is lower than the low fundamental frequency and (b) the actual current is higher than the continuous current rating; and
detecting a thermal cycling fault condition when the inverter has been in the thermal cycling operating condition for a sufficient period of time to cause its present stress factor to exceed a predetermined rated stress factor, the present stress factor being determined by monitoring both the actual current and the actual frequency as a function of time while the inverter is in the thermal cycling operating condition.

14. The program storage device of claim 13, wherein the program storage device is a programmable logic controller.

15. The program storage device of claim 13, wherein the actual frequency and the actual current are sensed in real time.

16. The program storage device of claim 13, wherein the rated stress factor is determined according to the following equation:
$${S}_{r} = \frac{{I}_{Stall , 30} - {I}_{Cont}}{{I}_{Cont}} \times T$$
where I_{Stall,30} is a stall current rating of the inverter, I_{Cont} is the continuous current rating, and T is a stall time constant.

17. The program storage device of claim 16, wherein the present stress factor is determined according to the following equation:
$${S}_{p} = Min [ Max [ \int \frac{I - {I}_{Cont}}{{I}_{Cont}} X \vert \frac{( \vert f \vert - {f}_{Stall , 30}}{{f}_{Stall , 30}} \vert d t , 0 ] , {S}_{r} ]$$
where I is the actual current, I_{Cont} is the continuous current rating, f is the actual frequency and f_{Stall,30} is the low fundamental frequency.

18. The program storage device of claim 17, the method further comprising the step of determining a dynamic stress margin according to the following equation:
Dₘ=Sᵣ−Sₚ
wherein the thermal cycling fault condition is detected when Dₘ equals zero.

19. The program storage device of claim 13, wherein the method calculates an estimated time to fault (ETF) when the inverter is in the thermal cycling operating condition but is not in the thermal cycling fault condition.

20. The program storage device of claim 18, wherein the method calculates an estimated time to fault (ETF) when the inverter is in the thermal cycling operating condition but is not in the thermal cycling fault condition according to the following equation:
$$E T F = \frac{{D}_{m}}{{S}_{p}} d t$$
wherein dt is a predetermined time interval.
